(19) United States
(12) Patent Application Publication
(10) Pub. No.: US 2009/0289838 A1
(43) Pub. Date: Nov. 26, 2009

(54) SYNTHETIC APERTURE RADAR AND METHOD FOR OPERATION OF A SYNTHETIC APERTURE RADAR

(75) Inventor: Hans Martin Braun, Salem (DE)

Correspondence Address: OCCHIUTI ROHLICEK & TSAO, LLP, 10 FAWCETT STREET, CAMBRIDGE, MA, 02138, US

(73) Assignee: RST Raumfahrt Systemtechnik GnbH, Salem (DE)

(21) Appl. No.: 12/392,349

(22) Filed: Feb. 25, 2009

(30) Foreign Application Priority Data
Feb. 25, 2008 (DE) 10 2008 010 772.7

(51) Int. Cl. G01S 13/90

(52) U.S. Cl. 342/25 A; 342/25 R

(57) ABSTRACT

The invention relates to a synthetic aperture radar, having a first transmitting and receiving unit for transmission and for reception of a first frequency band, and a second transmitting and receiving unit for transmission and for reception of a second frequency band. According to the invention, the first frequency band and the second frequency band are each provided as a polarized frequency band, and a polarized antenna unit is provided for combination of the first polarized frequency band and of the second polarized frequency band. The synthetic aperture radar according to the invention and the method according to the invention for operation of a synthetic aperture radar have the advantage that they allow better resolution.

The invention relates to a synthetic aperture radar, having a first transmitting and receiving unit for transmission and for reception of a first frequency band, and a second transmitting and receiving unit for transmission and for reception of a second frequency band, and to a method for operation of a synthetic aperture radar, with a first frequency band being transmitted and received, and a second frequency band being transmitted and received.

Synthetic aperture radars, or SAR for short, are of major importance in various fields of application, for example in aircraft or satellites, and are used, for example, for reconnaissance of the ground, map making or surveillance. The images produced by an SAR can be interpreted easily, because of their similarity to photographic recordings. SAR operates independently of the lighting conditions.

In an SAR, the resolution in the direction of flight is achieved by means of the integration time. There is virtually no realistic limit to this, that is to say the values which are required in the very near future can be achieved using the means known from the prior art. The geometric resolution in the range direction (in the case of the SAR geometry, transversely with respect to the direction of flight) depends on the radio-frequency bandwidth of the transmitted signal.

Various SAR implementations are known from the prior art. Fundamentally, a typical radar has a transmitter, a receiver, a circulator and an antenna. The transmitter transmits a signal, in particular a frequency band, via the antenna. The signal echo reflected from objects is received by the receiver via the antenna. The circulator separates the transmitted signal from the received signal.

In the designs of an SAR that are known from the prior art, the required signal bandwidth is inversely proportional to the resolution. Therefore, the smaller the resolution cell is required to be, the wider the bandwidth must be. Particularly in space flight, but also in the case of airborne SARs, the resolution is technologically limited by the required bandwidth.

The object of the invention is to specify a synthetic aperture radar and a method for operation of a synthetic aperture radar, which allow better resolution.

On the basis of the synthetic aperture radar described initially, this is achieved in that the first frequency band and the second frequency band are each provided as a polarized frequency band, and a polarized antenna unit is provided for combination of the first polarized frequency band and of the second polarized frequency band. The invention therefore envisages a combination of the two polarized frequency bands via one polarized antenna unit so as to allow a wider bandwidth, which leads to better resolution. The received and combined polarized frequency bands can be represented in a synthetic aperture radar. The two frequency bands preferably have different polarizations. It is also preferable for the antenna unit to illuminate the same target area with both polarized frequency bands. This makes it possible to achieve an improvement in the resolution in the range direction, in which case the entire required resolution in the direction of flight can be processed in conjunction with this within the azimuth compression.

The two polarized frequency bands are preferably closely adjacent to one another. It is very particularly preferable for there to be no space between the two polarized frequency bands. In one preferred development of the invention, furthermore, both transmitting and receiving units each have one transmitter for transmission of the respective polarized frequency band, each have one receiver for reception of the respective polarized frequency band, and each have one circulator for switching the respective polarized frequency band between the transmitter and the receiver. This means that each frequency band is guided as long as possible in a separate frequency band, thus making it easier to deal with the broadband nature. The two frequency bands are preferably transmitted and received at the same time.

In principle, the first and the second transmitting and receiving unit can be designed such that both frequency bands are transmitted with linear polarization. However, one preferred development of the invention provides that the first transmitting and receiving unit is designed such that the first polarized frequency band is transmitted left-circular polarized or right-circular polarized, respectively, and the second transmitting and receiving unit is designed such that the second polarized frequency band is transmitted right-circular polarized or left-circular polarized, respectively. In other words, the first transmitter is accordingly designed such that the first frequency band is transmitted with left-circular polarization and the second transmitter is designed such that the second frequency band is transmitted with right-circular polarization, or the first transmitter is designed such that the first frequency band is transmitted with right-circular polarization and the second transmitter is designed such that the second frequency band is transmitted with left-circular polarization.

It is very particularly preferable for the polarized antenna unit to be in the form of a circular-polarized antenna. In this case, a circulation duplexer can be provided, which passes a received echo via the respective circulator, which is used only for one frequency band in each case, to the respective receiver. The resolution of an SAR, particularly in the case of complex targets which, for example, comprise surfaces as well as lines, is improved by using circular polarization, in contrast to linear polarization.

It is also preferable for the polarized antenna unit to be in the form of a reflector antenna with a circular polarizer, with the reflector antenna having a feedhorn, and the circular polarizer, in particular a polarization filter, being arranged at the input to the feedhorn. In this case, the reflector antenna may be in the form of a parabolic antenna, in which a metallic rotation paraboloid forms the reflector. This makes it possible to significantly influence the directional characteristic of the parabolic antenna, and thus the directional effect of the parabolic antenna.

Furthermore, in one preferred development of the polarized antenna unit, the polarized antenna unit is in the form of a phased array antenna with a circular-polarized antenna element. In this case, it is possible to provide for in each case one input and one output to be provided for each polarization direction, that is to say left-circular or right-circular polarization. A polarization filter is preferably arranged in front of the emission surface of a model of the phased array antenna.

It is very particularly preferable that an input filter for filtering of signal components of the respective other frequency band is provided upstream of the receiver. In particular, the input filter can be designed such that signal components in the form of crosstalk from the respective other frequency band are filtered out, or are approximately completely filtered out. This makes it possible to ensure that the respective receiver receives only, or approximately only, those signal components which correspond to the respective frequency band.

According to one development of the invention, it is preferable that a steep-flank filter for subdivision of the respective polarized frequency band into further polarized frequency bands is provided upstream of the receiver. The steep-flank filter is preferably arranged upstream of the previously mentioned input filter. It is particularly preferable for the respective polarized frequency band to be subdivided into further polarized frequency bands when the receiver cannot receive the entire polarized frequency band without subdividing it. In a situation such as this, further receivers can be provided, in which case each further receiver can be provided in order to receive one further, subdivided frequency band.

According to one preferred embodiment of the invention, the radar has a device for phase correction of the received polarized frequency band and at least one device for SAR processing of the phase-corrected polarized frequency band. In particular, it is possible to provide at least two devices for SAR processing with one device for phase correction. The device for phase correction is preferably connected upstream of the device for SAR processing.

Against the background of the method as described initially for operation of a synthetic aperture radar, the object mentioned further above is achieved in that the first frequency band and the second frequency band are each transmitted and/or received in a polarized manner, and the received echoes of the first polarized frequency band and of the second polarized frequency band are combined.

In principle, both frequency bands can be transmitted in a linear-polarized manner. However, according to one preferred development of the invention, the first polarized frequency band is transmitted left-circular polarized or right-circular polarized, respectively, and the second polarized frequency band is transmitted right-circular polarized or left-circular polarized, respectively. In other words, the first frequency band is transmitted with left-circular polarization and the second frequency band is transmitted with right-circular polarization, or the first frequency band is transmitted with right-circular polarization and the second frequency band is transmitted with left-circular polarization.

In one preferred development of the method, signal components of one polarized frequency band are in each case filtered before reception of the respective other polarized frequency band. In particular, the filtering can be carried out in such a manner that signal components in the form of crosstalk from the respective other frequency band are filtered out or are approximately completely filtered out.

It is also preferable, before reception, for the respective polarized frequency band to be subdivided into further polarized frequency bands. The subdivision into further polarized frequency bands is preferably carried out by filtering, in particular by steep-flank filtering. It is very particularly preferable for a subdivision such as this into further polarized frequency bands to be carried out before, as mentioned already, signal components of the respective other polarized frequency band are filtered.

It is very particularly preferable for the received echoes of the first polarized frequency band and of the second polarized frequency band to be combined in SAR processing, and for the echoes of targets which behave in the same manner or in a similar manner in terms of power and phase for both polarizations to result in a resolution which results from the sum bandwidth of the two polarized frequency bands.

It is also preferable for the received echoes to be combined such that the result can be displayed in images with two or more different linear combinations. For example, this makes it possible to distinguish between linear target structures and two-dimensional target structures.

In principle, the two frequency bands can be transmitted at the same time. However, it is very particularly preferable for the polarized frequency bands to be transmitted alternately and sequentially, for them to be received in the sum bandwidth of the polarized frequency bands, and for it to be possible to evaluate the combination of the received echoes polarimetrically. For this purpose, the first frequency band is preferably received with a copolar or cross-copolar component in a first pulse repetition interval, and the second frequency band is received with a copolar or cross-copolar component in a second pulse repetition interval.

Other preferred developments of this method result analogously to the preferred developments of the radar according to the invention, as described above.

The radar described above and the method for operation of a radar are preferably used in aircraft or satellites and are used, for example, for ground reconnaissance, map making or surveillance. Further fields of application include ground-based, sea-based or aircraft-based reconnaissance.

The invention will be described in detail in the following text using preferred exemplary embodiments and with reference to the drawing, in which:

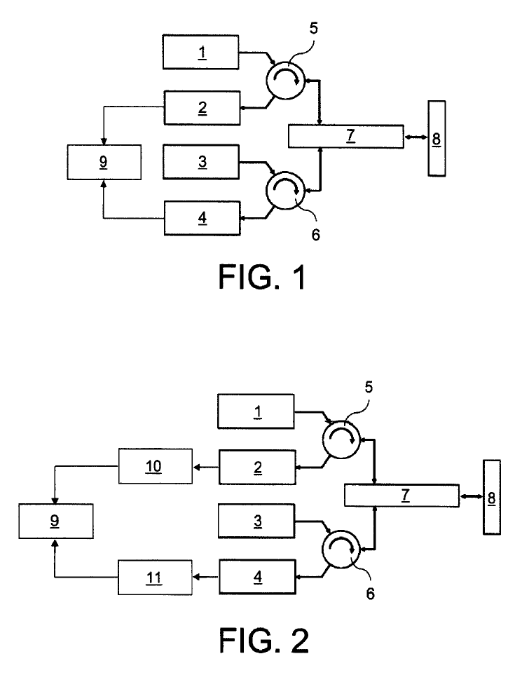

FIG. 1 shows a schematic illustration with the major functional blocks of the radar, according to a first preferred exemplary embodiment of the invention,

FIG. 2 shows a schematic illustration with the major functional blocks of the radar, according to a second preferred exemplary embodiment of the invention, and

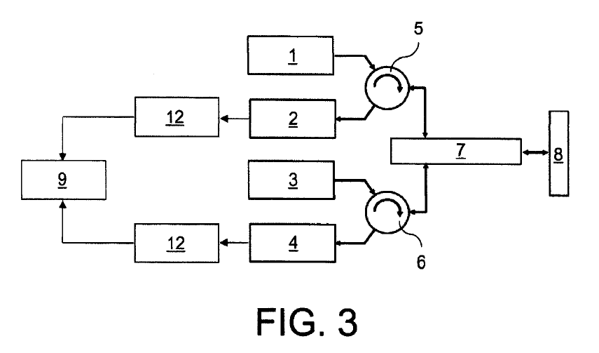

FIG. 3 shows a schematic illustration with the major functional blocks of the radar, according to a third preferred exemplary embodiment of the invention.

As already indicated above, the resolution in the direction of flight in a synthetic aperture radar (SAR) is achieved by the integration time. There is scarcely any realistic limit to this, that is to say the values required in the very near future can be achieved with the means known from the prior art. The geometric resolution in the range direction (in the case of the SAR geometry transversely with respect to the direction of flight) depends on the radio-frequency bandwidth of the transmitted signal. The narrower the resolution cell is required to be, the wider the bandwidth must be.

The SARs which are known from the prior art are in this case running into the limits of feasibility in the radio-frequency assemblies, particularly in the area of power amplifiers. The attempt to split the bandwidth between two power amplifiers has failed in the systems known from the prior art since an SAR sensor must transmit its signal from one antenna with a defined phase center. Systems with different phase centers are admittedly described from the prior art, for example array antennas with a plurality of modules; however, these all operate with the same exactly parallel transmission signals, thus resulting in a common phase center at the center of the antenna. This mode does not make it possible to split different signals between different modules and then to use these jointly to form the synthetic aperture. Furthermore, components for combination of a plurality of channels (“magic T”) are also known, but these refinements also demand a high degree of match between the signals in the channels to be combined.

The present invention makes use of the characteristic of targets that circular-polarized signals, irrespective of whether they are left-circular or right-circular polarized, are sent back as echoes with the same amplitudes and the same phases. This applies both to two-dimensional targets and to linear targets, with the reflection characteristics differing only by the transformation from left-circular to right-circular polarization (and vice-versa), but not in the magnitude and phase of the reflection. This is made use of by transmitting and receiving one frequency band with the one form of circular polarization and the other frequency band with the other form of polarization. During subsequent operation of the channels, with a change from one pulse to the next, the cross-polarization components can also be evaluated, thus making it possible to distinguish between single and double reflections.

In this case, the signals are produced in a coherent form, that is to say derived from a common mother oscillator. The echoes are converted to baseband separately but coherently in the receiver, and are then combined. The common pulse compression is then carried out. It is also possible to carry out the pulse compression of the two channels separately but coherently, and then to add the compressed echoes in a complex form.

FIGS. 1 to 3 each show a schematic illustration of a synthetic aperture radar according to one preferred exemplary embodiment of the invention. A radar such as this is used for two-dimensional representation of a terrain detail by scanning the earth's surface, and has a first transmitter 1, a first receiver 2, a second transmitter 3 and a second receiver 4.

The first transmitter 1 transmits a left-circular or right-circular polarized first frequency band, which is received by the first receiver 2. A first circulator 5 is provided in order to switch the first polarized frequency band between the first transmitter 1 and the first receiver 2. The second transmitter 3 transmits a right-circular or left-circular polarized second frequency band, respectively, which is received by the second receiver 4. A second circulator 6 is provided in order to switch the second polarized frequency band between the second transmitter 3 and the second receiver 4. In other words, one frequency band is transmitted with left-circular or right-circular polarity, respectively, while the other frequency band is transmitted with right-circular or left-circular polarization, respectively.

According to the exemplary embodiment described here, the first polarized frequency band and the second polarized frequency band are combined in a circular polarizer 7, which is provided at the input of a circular-polarized antenna, in particular at the input to the feedhorn of a reflector antenna 8.

As stated above, the invention makes use of the characteristic of artificial targets such as buildings, vehicles or marine vessels, which send back circular waves uniformly in amplitude and phase, irrespective of whether they are right-circular or left-circular polarized waves. This likewise applies to the rotation of the polarization direction. This makes it possible to split the required bandwidth into two different polarizations, right-circular and left-circular, to pass them through different power amplifiers, for example transmitters, to pass them via a common antenna, and to process them jointly in the receiver, in the sum of the bandwidths. This makes it possible to achieve an improvement in the resolution in the range direction, in which case, nevertheless, the overall required resolution in the direction of flight can be processed in conjunction with this, within the azimuth compression.

These identical reflection characteristics of a target, which allow echoes produced with right-circular polarization to be combined coherently with echoes produced with left-circular polarization, and thus allow two mutually adjacent frequency bands to be combined to form a common echo signal with the sum of the bandwidths of the individual bands, in order then to convert this high sum bandwidth, in the course of pulse compression, to a resolution which is higher than the resolution of the individual bands.

The reflection parameters of linear polarization on the abovementioned targets are different since a linear transmission polarization is reflected by parallel linear structures, but not by vertical linear structures. In contrast, cross-polarization effects are the same and are independent of whether they are caused by vertical or horizontal polarization.

Circular polarization is preferably used for the behavior described above. Furthermore, the band combination can also be carried out with linear polarization since, from the mathematical point of view, both polarizations are identical and can be converted to one another. When using linear polarization, it is necessary to receive both polarization directions in each frequency range and, if possible, also to transmit them in this way, since, otherwise, the mathematical conversion cannot be carried out with the necessary accuracy before superimposition of the two frequency bands.

If there is no need to distinguish between copolarization and cross-polarization, the two frequency bands can be transmitted at the same time. This has the advantage that it is possible to choose the lowest possible pulse repetition frequency, thus resulting in the maximum strip width.

When receiving echoes or in particular reflections from two-dimensional target structures, the reflection factor is constant over time and the rotation of the polarization vector does not produce different phases in the received signal. The two frequency bands together result in the resolution.

In the case of reflection on a narrow linear target, for example on a ventilation grid of an aircraft or on an iron fence, the incident transmitted signal or frequency band is split into a copolar component and a cross-copolar component. In this case, amplitude modulation is superimposed on the received signal, which modulation contains only one of these components, and its phase depends on the alignment of the linear reflector.

As can be seen from FIG. 1, linear polarization records can be simulated by phase correction in the case of band combination and subsequent SAR processing, in a device for SAR processing 9, with different phase combinations, and can be displayed in the image, in particular with at least two SAR processings being carried out.

Furthermore, as can be seen from FIG. 2, the first polarized frequency band is phase-corrected in a first device for phase correction 10, and the second polarized frequency band is phase-corrected in a second device for phase correction 11. The phase correction can be carried out with or without the inclusion of the cross-polarization component.

If it is also intended to determine the cross-polarization component, the pulse repetition frequency can be doubled, and the frequency bands transmitted alternately, as shown in FIG. 3. In this case, the phase correction for the first and for the second polarized frequency band 12 is carried out in each case.

The cross-polarization component in the case of circular polarization contains the components of linear reflectors and of double reflections, since the rotation direction of circular-polarized signals is in each case reversed on reflection. This feature contributes to the identification of, for example, marine vessels, vehicles or stationary aircraft.

1. Synthetic aperture radar, having
a first transmitting and receiving unit for transmission and for reception of a first frequency band, and
a second transmitting and receiving unit for transmission and for reception of a second frequency band,
characterized in that
the first frequency band and the second frequency band are each provided as a polarized frequency band, and
a polarized antenna unit is provided for combination of the first polarized frequency band and of the second polarized frequency band.

2. Radar according to claim 1, characterized in that both transmitting and receiving units each have one transmitter for transmission of the respective polarized frequency band, each have one receiver for reception of the respective polarized frequency band, and each have one circulator for switching the respective polarized frequency band between the transmitter and the receiver.

3. Radar according to claim 1, characterized in that the first transmitting and receiving unit is designed such that the first polarized frequency band is transmitted left-circular polarized or right-circular polarized, respectively, and the second transmitting and receiving unit is designed such that the second polarized frequency band is transmitted right-circular polarized or left-circular polarized, respectively.

4. Radar according to claim 3, characterized in that the polarized antenna unit is in the form of a circular-polarized antenna.

5. Radar according to claim 3, characterized in that the polarized antenna unit is in the form of a reflector antenna with a circular polarizer, with the reflector antenna having a feedhorn, and the circular polarizer being arranged at the input to the feedhorn.

6. Radar according to claim 3, characterized in that the polarized antenna unit is in the form of a phased array antenna with a circular-polarized antenna element.

7. Radar according to claim 2, characterized in that an input filter for filtering of signal components of the respective other frequency band is provided upstream of the receiver.

8. Radar according to claim 7, characterized in that a steep-flank filter for subdivision of the respective polarized frequency band into further polarized frequency bands is provided upstream of the receiver.

9. Radar according to claim 2, characterized in that a device is provided for phase correction of the received polarized frequency band, and a device is provided for SAR processing of the phase-corrected polarized frequency band.

10. Method for operation of a synthetic aperture radar, with
a first frequency band being transmitted and received, and
a second frequency band being transmitted and received,
characterized in that
the first frequency band and the second frequency band are each transmitted and/or received in a polarized manner, and
the received echoes of the first polarized frequency band and of the second polarized frequency band are combined.

11. Method according to claim 10, characterized in that the first polarized frequency band is transmitted left circular polarized or right-circular polarized, respectively, and the second polarized frequency band is transmitted right circular polarized or left-circular polarized, respectively.

12. Method according to claim 10, characterized in that signal components of one polarized frequency band are in each case filtered before reception of the respective other polarized frequency band.

13. Method according to claim 12, characterized in that, before reception, the respective polarized frequency band is subdivided into further polarized frequency bands.

14. Method according to claim 10, characterized in that the received echoes of the first polarized frequency band and of the second polarized frequency band are combined in SAR processing, in that the echoes of targets which behave in the same manner or in a similar manner in terms of power and phase for both polarizations result in a resolution which results from the sum bandwidth of the two polarized frequency bands.

15. Method according to claim 14, characterized in that the received echoes are combined such that the result can be displayed in images with two or more different linear combinations.

16. Method according to claim 11, characterized in that the polarized frequency bands are transmitted alternately and sequentially, reception takes place in the sum bandwidth of the polarized frequency bands, and the combination of the received echoes can be evaluated polarimetrically.

17. Radar according to claim 2, characterized in that the first transmitting and receiving unit is designed such that the first polarized frequency band is transmitted left-circular polarized or right-circular polarized, respectively, and the second transmitting and receiving unit is designed such that the second polarized frequency band is transmitted right-circular polarized or left-circular polarized, respectively.

18. Radar according to claim 17, characterized in that the polarized antenna unit is in the form of a circular-polarized antenna.

19. Radar according to claim 17, characterized in that the polarized antenna unit is in the form of a reflector antenna with a circular polarizer, with the reflector antenna having a feedhorn, and the circular polarizer being arranged at the input to the feedhorn.

20. Radar according to claim 17, characterized in that the polarized antenna unit is in the form of a phased array antenna with a circular-polarized antenna element.
